(19) United States
(12) Patent Application Publication
(10) Pub. No.: US 2020/0320976 A1
(43) Pub. Date: Oct. 8, 2020

(54) INFORMATION PROCESSING APPARATUS, INFORMATION PROCESSING METHOD, AND PROGRAM

(71) Applicant: SONY CORPORATION, Tokyo (JP)

(72) Inventors: Shinichi KAWANO, Tokyo (JP); Yuhei TAKI, Kanagawa (JP)

(73) Assignee: SONY CORPORATION, Tokyo (JP)

(21) Appl. No.: 16/305,328

(22) PCT Filed: Aug. 17, 2017
(86) PCT No.: PCT/JP2017/029492

§ 371 Date: Nov. 28, 2018

(30) Foreign Application Priority Data
Aug. 31, 2016 (JP) 2016-170307

(51) Int. Cl. G10L 15/02; G10L 15/26; G10L 25/78; G06F 40/279

(52) U.S. Cl. CPC G10L 15/02; G06F 40/279; G10L 25/78; G10L 15/26

(57) ABSTRACT

The present invention relates to an information processing apparatus, an information processing method, and a program that enable more preferable audio input. On the basis of a feature of the speech and a specific silent period detected from audio information, any of audio recognition processing of a normal mode and audio recognition processing of a special mode is selected, and along with an audio recognition result obtained by recognition in the selected audio recognition processing, audio recognition result information indicating the audio recognition processing with which the audio recognition result has been obtained is output. The present technology can be applied to, for example, an audio recognition system that provides audio recognition processing via a network.

### TECHNICAL FIELD

The present invention relates to an information processing apparatus, an information processing method, and a program, and in particular, to an information processing apparatus, an information processing method, and a program that enable more preferable audio input.

### BACKGROUND ART

In recent years, utilization of a user interface using audio input has been widespread, and it is important to realize audio recognition processing that enables more preferable audio input.

Generally, in the audio recognition processing, processing of extracting a feature amount with respect to audio information is performed, and feature amounts such as mel-frequency cepstrum coefficients (MFCC) are extracted, for example. Then, on the basis of the feature amount extracted from the audio information, an audio recognition engine performs audio recognition processing with reference to an acoustic model, a recognition dictionary, and a language model, and a character string recognized from the audio is output.

For example, Patent Document 1 discloses an audio recognition system that selects an acoustic model to be used for audio recognition on the basis of a user's classification in audio recognition targeting an unspecified number of users.

### CITATION LIST

### Patent Document

Patent Document 1: Japanese Patent Application Laid-Open No. 2000-347684

### SUMMARY OF THE INVENTION

### Problems to be Solved by the Invention

By the way, in applications for inputting messages in game chat, live distribution platform, or the like, not only sentences with normal words and phrases but also a special character string that is not listed in a recognition dictionary such as identification (ID), abbreviations, proper nouns, or net slang may be input. It is difficult to accurately perform audio recognition processing on such a special character string, and it is difficult to perform preferable audio input.

The present invention has been made in view of such a situation, and it is intended to make it possible to perform more preferable audio input.

### Solutions to Problems

An information processing apparatus of an aspect of the present disclosure includes: a speech feature detection unit that acquires audio information obtained by a speech of a user and detects a feature of the speech from the audio information; a specific silent period detection unit that detects a specific silent period that is a specific short silent period not determined as a silent period in processing of detecting a speech section in which the audio information includes audio; a selection unit that selects audio recognition processing to be performed on the audio information on the basis of the feature of the speech that has been detected from the audio information by the speech feature detection unit, and the specific silent period that has been detected from the audio information by the specific silent period detection unit; and an output processing unit that outputs, along with an audio recognition result obtained by recognition in the audio recognition processing that has been selected by the selection unit, an audio recognition result information indicating the audio recognition processing in which the audio recognition result has been obtained.

An information processing method or a program of an aspect of the present disclosure includes steps of: acquiring audio information obtained by a speech of a user and detecting a feature of the speech from the audio information; detecting a specific silent period that is a specific short silent period not determined as a silent period in processing of detecting a speech section in which the audio information includes audio; selecting audio recognition processing to be performed on the audio information on the basis of the feature of the speech that has been detected from the audio information, and the specific silent period that has been detected from the audio information; and outputting, along with an audio recognition result obtained by recognition in the audio recognition processing that has been selected, an audio recognition result information indicating the audio recognition processing in which the audio recognition result has been obtained.

In one aspect of the present disclosure, in the processing of acquiring the audio information obtained by the speech of the user, detecting the feature of the speech from voice information, and detecting the speech section in which the audio information includes audio, a specific silent period that is a specific short silent period not determined as a silent period is detected. Then, on the basis of the feature of the speech that has been detected from the audio information and the specific silent period that has been detected from the audio information, the audio recognition processing to be performed on the audio information is selected, and along with the audio recognition result obtained by recognition in the audio recognition processing, the audio recognition result information indicating that the audio recognition processing has been performed is output.

### Effects of the Invention

According to one aspect of the present disclosure, more preferable audio input can be performed.

### BRIEF DESCRIPTION OF DRAWINGS

FIG. 1 is a block diagram showing a configuration example of an audio recognition system according to an embodiment to which the present technology is applied.

FIG. 2 is a block diagram showing a configuration example of an audio recognition server.

FIG. 3 is a diagram showing an example of a character string number conversion table.

FIG. 4 is a diagram showing an example of a basic user interface of audio recognition processing.

FIG. 5 is a diagram for explaining comparison of audio levels.

FIG. 6 is a diagram showing an example of a user interface in audio recognition processing of a normal mode.

FIG. 7 is a diagram for explaining comparison of audio levels and detection of a specific silent period.

FIG. 8 is a diagram showing an example of a user interface in a one-character mode and an uppercase conversion mode.

FIG. 9 is a diagram showing an example of an audio recognition result.

FIG. 10 is a diagram for explaining comparison of audio levels and detection of the specific silent period.

FIG. 11 is a diagram showing an example of a user interface in a one-character mode and a number conversion mode.

FIG. 12 is a diagram showing an example of the audio recognition result.

FIG. 13 is a flowchart explaining audio recognition processing.

FIG. 14 is a diagram showing an example of a user interface in audio recognition processing for Japanese.

FIG. 15 is a diagram showing an example of an API for realizing the audio recognition processing.

FIG. 16 is a diagram showing an example of emphasizing and displaying the audio recognition result.

FIG. 17 is a diagram showing another example of emphasizing and displaying the audio recognition result.

FIG. 18 is a block diagram showing a configuration example of an embodiment of a computer to which the present technology is applied.

### MODE FOR CARRYING OUT THE INVENTION

Specific embodiments to which the present technology is applied will be described in detail below with reference to the drawings.

<Configuration Example of Audio Recognition System>

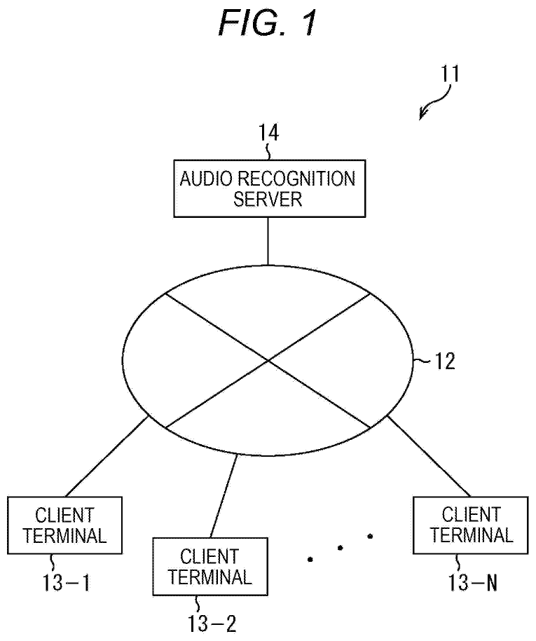

FIG. 1 is a block diagram showing a configuration example of an audio recognition system according to an embodiment to which the present technology is applied.

As shown in FIG. 1, a plurality of (N in the example of FIG. 1) client terminals 13-1 to 13-N and an audio recognition server 14 are connected to an audio recognition system 11 via a network 12 such as the Internet. Note that the client terminals 13-1 to 13-N are configured similarly to each other, and hereinafter, are referred to as a client terminal 13 as appropriate in a case where there is no need to distinguish each other.

The client terminal 13 is provided with an audio information acquisition device such as a microphone for inputting audio given by a speech of a user and acquiring audio information, and transmits the audio information acquired by the audio information acquisition device to the audio recognition server 14 via the network 12. Furthermore, the client terminal 13 receives the audio recognition result transmitted from the audio recognition server 14 and presents the result to the user. For example, the client terminal 13 causes a video output device to display a user interface representing an audio recognition result, and outputs synthesized audio representing the audio recognition result from the audio output device.

The audio recognition server 14 performs audio recognition processing on the audio information transmitted from the client terminal 13 via the network 12. Then, the audio recognition server 14 transmits a word string or the like recognized from the audio information as the audio recognition result to the client terminal 13 via the network 12. At this time, the audio recognition server 14 can transmit the audio recognition result not only to the client terminal 13 that has transmitted the audio information, but also to, for example, the client terminal 13 of another user who is communicating with the user of the client terminal 13.

The audio recognition system 11 is configured as described above, the audio information obtained by the speech of the user of the client terminal 13 is transmitted to the audio recognition server 14, audio recognition processing is performed in the audio recognition server 14, and the audio recognition result is transmitted to the client terminal 13. Therefore, for example, the latest higher-performance audio recognition processing is implemented in the audio recognition server 14, so that the audio recognition system 11 can provide audio recognition processing that enables more preferable audio input even if the processing capability of each client terminal 13 is low.

<First Configuration Example of Audio Recognition Server>

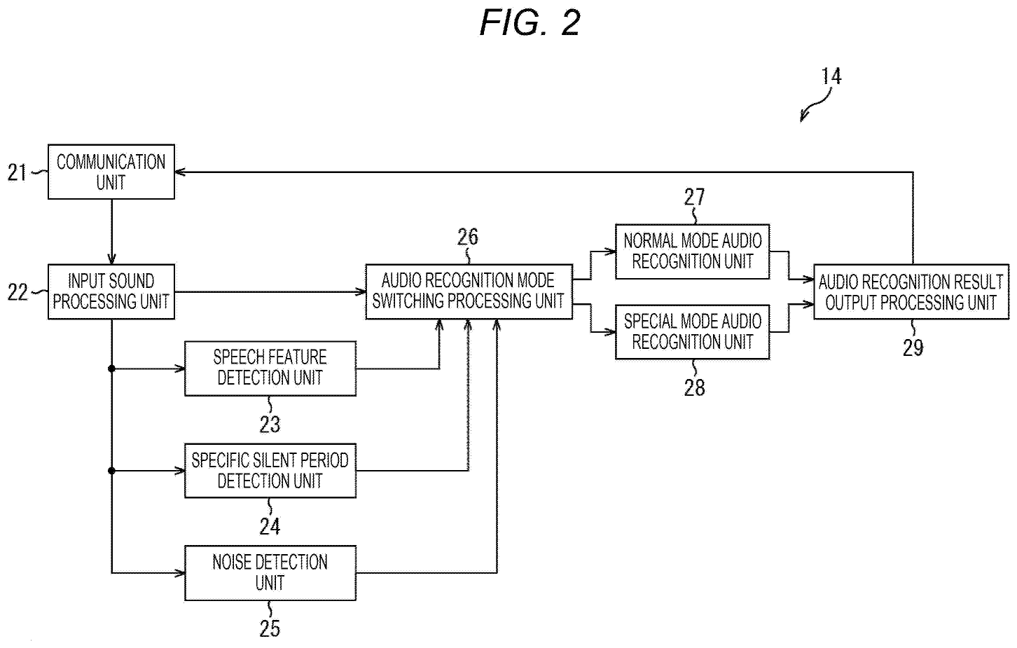

FIG. 2 is a block diagram showing a first configuration example of the audio recognition server 14.

As shown in FIG. 2, the audio recognition server 14 includes a communication unit 21, an input sound processing unit 22, a speech feature detection unit 23, a specific silent period detection unit 24, a noise detection unit 25, an audio recognition mode switching processing unit 26, a normal mode audio recognition unit 27, a special mode audio recognition unit 28, and an audio recognition result output processing unit 29.

The communication unit 21 performs various types of communication with the client terminal 13 via the network 12 in FIG. 1. For example, the communication unit 21 receives the audio information transmitted from the client terminal 13 and supplies the audio information to the input sound processing unit 22. Furthermore, the communication unit 21 transmits the audio recognition result information supplied from the audio recognition result output processing unit 27 to the client terminal 13.

The input sound processing unit 22 performs various pre-processing necessary before the audio recognition is performed in the normal mode audio recognition unit 27 and the special mode audio recognition unit 28, with respect to the audio information supplied from the communication unit 21. For example, the input sound processing unit 22 excludes a section that is silent in the audio information and a section that includes only noise, performs voice activity detection (VAD) processing for detecting the speech section including audio given by a speech from audio information, and acquires the audio information of the speech section. Then, the input sound processing unit 22 supplies the audio information of the speech section to the speech feature detection unit 23, the specific silent period detection unit 24, the noise detection unit 25, and the audio recognition mode switching processing unit 26.

The speech feature detection unit 23 detects the feature of the speech of the user from the audio information of the speech section supplied from the input sound processing unit 22 and supplies the speech feature detection result indicating the feature of the detected speech to the audio recognition mode switching processing unit 26.

For example, the speech feature detection unit 23 detects the audio level of the audio based on the audio information as a feature of a speech, and sets a result of comparison between the audio level of the audio based on the audio information and the preset audio level at the normal time as a speech feature detection result. Furthermore, for example, the speech feature detection unit 23 detects the input speed of the audio based on the audio information as a feature of the speech, and sets the comparison result obtained by relatively comparing with the input speed of the audio until then (becomes faster or slower than the speed until then) as the speech feature detection result. Furthermore, for example, the speech feature detection unit 23 detects the frequency of the audio based on the audio information as a feature of the speech, and sets the comparison result obtained by relatively comparing with the frequency of the audio until then (becomes higher or lower than the frequency until then) as the speech feature detection result.

The specific silent period detection unit 24 detects an extremely short silent period that is not determined as a silent period as a specific silent period in the VAD processing in which the input sound processing unit 22 detects the speech section from the audio information from the audio information of the speech section supplied from the input sound processing unit 22. For example, the specific silent period is a short silent period occurring at the end of speech of each alphabet when speech of alphabets is performed one character by one character, which is called so-called an interval. Then, the specific silent period detection unit 24 supplies the specific silent period detection result indicating the timing and the interval at which the specific silent period has been detected from the audio information of the speech section, to the audio recognition mode switching processing unit 26.

The noise detection unit 25 detects the audio level of the noise included in the audio information of the speech section supplied from the input sound processing unit 22 and supplies the audio level of the detected noise to the audio recognition mode switching processing unit 26.

The audio recognition mode switching processing unit 26 performs processing of switching audio recognition processing on the basis of the speech feature detection result supplied from the speech feature detection unit 23, the specific silent period detection result supplied from the specific silent period detection unit 24, and the audio level of the noise supplied from the noise detection unit 25.

For example, in a case where the audio level of the audio based on the audio information is lower than the audio level at the normal time on the basis of the speech feature detection result, the audio recognition mode switching processing unit 26 selects the audio recognition processing of the normal mode. On the other hand, in a case where the audio level of the speech based on the audio information is higher than the audio level at the normal time on the basis of the speech feature detection result, and the specific silent period is repeatedly detected at predetermined intervals on the basis of the specific silent period detection result, the audio recognition mode switching processing unit 26 considers that the condition for performing the audio recognition processing of the special mode has occurred, and selects the audio recognition processing of the special mode.

Furthermore, in a case where the input speed of the audio based on the audio information is relatively slower, and also in a case where the frequency of the audio based on the audio information is relatively high, on the basis of the speech feature detection result, the audio recognition mode switching processing unit 26 considers that the condition for performing the audio recognition processing of the special mode has occurred, and selects the audio recognition processing of the special mode, as similar to the case where the audio level of the audio based on the audio information is higher than the audio level at the normal time.

Here, for example, in a case where a user speaks to repeat a short speech and an interval after an interval at a volume larger than normal, it can be considered that the input of the audio of one character by one character such as inputting of ID is being performed. Therefore, in this case, it is preferable that the audio recognition mode switching processing unit 26 selects the special mode audio recognition processing for performing audio recognition of one character by one character as described above.

Moreover, in a case where the audio level of the noise exceeds the preset predetermined audio level, the audio recognition mode switching processing unit 26 avoids the selection of audio recognition processing of the special mode. In other words, in a case where the noise is large, it is considered that the recognition accuracy of the audio recognition processing of the special mode is deteriorated, so that it is preferable that the audio recognition processing of the special mode is not selected.

Then, in a case where the audio recognition processing of the normal mode is selected, the audio recognition mode switching processing unit 26 supplies the audio information of the speech section supplied from the input sound processing unit 22 to the normal mode audio recognition unit 27. On the other hand, in a case where the audio recognition processing of the special mode is selected, the audio recognition mode switching processing unit 26 supplies the audio information of the speech section supplied from the input sound processing unit 22 to the special mode audio recognition unit 28.

For example, the normal mode audio recognition unit 27 refers to a general recognition dictionary and performs audio recognition processing on audio information supplied from the audio recognition mode switching processing unit 26, as similar to the conventional case. Then, the normal mode audio recognition unit 27 supplies, for example, a character string recognized from the audio information to the audio recognition result output processing unit 29 as an audio recognition result.

The special mode audio recognition unit 28 performs audio recognition processing of the special mode for recognizing special character strings such as ID, abbreviation, proper noun, or net slang (hereinafter referred to as special characters as appropriate) from the audio information supplied from the audio recognition mode switching processing unit 26. Examples of the audio recognition processing of the special mode include a one-character mode for performing audio recognition of one character by one character, an uppercase conversion mode for converting the audio recognition result to uppercase letters of the alphabet, a number conversion mode for converting words of the audio recognition result into numbers, and the like.

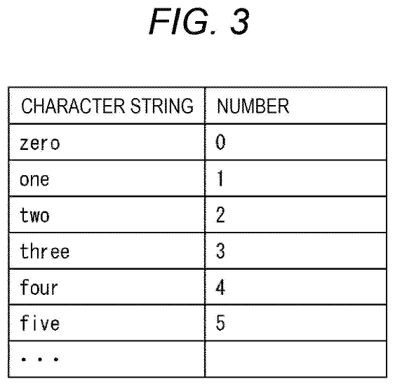

For example, in a case where the specific silent period is repeatedly detected at predetermined intervals, the special mode audio recognition unit 28 considers that input of the audio of one character by one character such as input of an ID is being performed, and performs the audio recognition processing of the special mode in the one-character mode. Furthermore, in a case where the audio level of the audio based on the audio information exceeds the audio level at the normal time in the one-character mode, the special mode audio recognition unit 28 performs the audio recognition processing of the special mode in the uppercase conversion mode for converting the recognized one character to an uppercase letter of the alphabet. Furthermore, in a case where the special mode audio recognition unit 28 refers to the character string number conversion table as shown in FIG. 3, and the word recognized by the audio recognition is registered in the character string number conversion table, the special mode audio recognition unit 28 performs the audio recognition processing of the special mode in the number conversion mode for converting the recognized word into a number.

The audio recognition result output processing unit 29 generates the audio recognition result information indicating the audio recognition processing in which the audio recognition result is obtained, and supplies to the communication unit 21, the audio recognition result and the information along with the audio recognition result supplied from the normal mode audio recognition unit 27 or the special mode audio recognition unit 28. For example, the audio recognition result output processing unit 29 generates as audio recognition result information, display information for causing the user interface that causes the user of the client terminal 13 to recognize that the audio recognition result and the audio recognition processing to be displayed, synthesized audio information for output of synthesized audio for recognition of the audio recognition result and the audio recognition processing, or the like.

The audio recognition server 14 is configured in this way, and can perform any of audio recognition processing by switching the audio recognition processing of the normal mode or the audio recognition processing of the special mode, with respect to the audio information transmitted from the client terminal 13 via the network 12. Then, the audio recognition server 14 can transmit the audio recognition result information obtained by performing the audio recognition processing to the client terminal 13 via the network 12, and can present, along with the audio recognition result, the audio recognition processing in which the audio recognition result has been obtained, to the user.

Therefore, the audio recognition server 14 can recognize, for example, a special character that cannot be recognized by simply referring to a general recognition dictionary, by the audio recognition processing of the special mode, and provide more preferable audio input.

For example, conventionally, performing audio recognition on special characters not listed in a recognition dictionary such as IDs, abbreviations, proper nouns, or net slang is more difficult due to a technical characteristic of audio recognition (characteristic of recognizing by using a recognition dictionary in which phrases are registered). Furthermore, such special characters are often changed in the expression method depending on the usage scene or the like and it is not realistic to register all the special characters in the recognition dictionary.

Specifically, the abbreviation “lol” is sometimes used for the English phrase “laughing out loud”, and as the pronunciation of the abbreviation “lol”, the letters are read one character by one character, “L, O, L”, in some cases, or the “lol” is pronounced as one word in some cases. Moreover, the notation may change due to differences in nuances such as “LOLOLOLOL”, “lolz” “lul”, or the like as a variation (notation differences) of the abbreviation “lol”. In addition to this example, similar abbreviations may be used, and it is extremely difficult to reflect all of them in the dictionary. Moreover, since IDs, abbreviations, proper nouns, net slang, or the like increase daily, it is considered that the cost is too high for reflecting them in the dictionary. Furthermore, words that are used only by members of a specific group of a social network and the like are not usually reflected in the recognition dictionary.

On the other hand, when a condition for performing the above-described audio recognition processing of the special mode occurs, the special mode audio recognition unit 28 performs the audio recognition processing of the special mode, so that the audio recognition server 14 can perform audio recognition on special characters more accurately than in the conventional case. As a result, the audio recognition server 14 can provide more preferable audio input by appropriately selecting the audio recognition processing even in a case where the normal conversation and the speech with the special characters coexist.

<Audio Recognition Processing of Audio Recognition System>

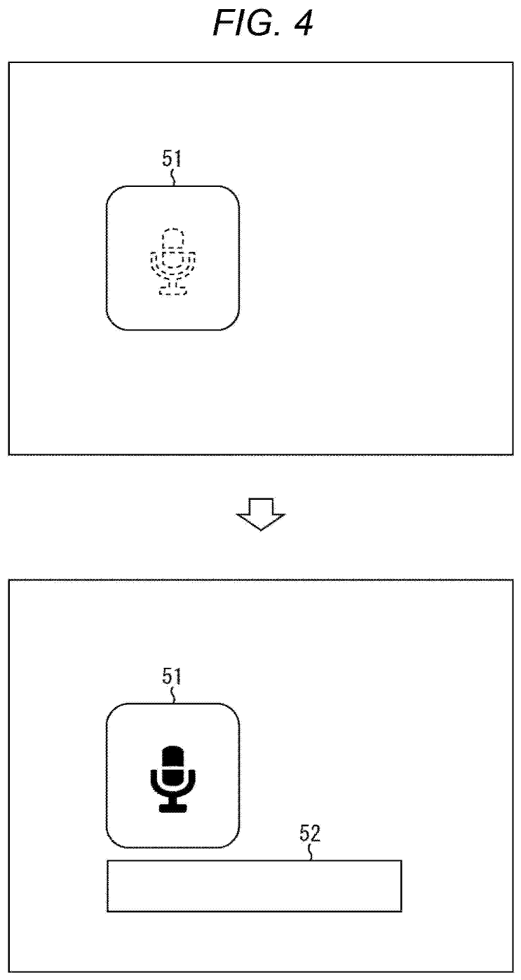

The audio recognition processing provided by the audio recognition system 11 will be described with reference to FIGS. 4 to 12.

Here, in FIGS. 4 to 12, description will be given of the audio recognition processing performed in the audio recognition server 14 with respect to the audio information, “Let's start this battle BTX505”, spoken by the user of the client terminal 13.

For example, on the screen of the video output device of the client terminal 13, an icon 51 representing the speech state of the user is displayed. When the speech of the user is not detected, as shown in the upper part of FIG. 4, a microphone in the icon 51 is displayed lightly (by broken line in the example of FIG. 4). Then, when the audio information acquisition device of the client terminal 13 detects the speech of the user, as shown in the lower part of FIG. 4, the display of the microphone in the icon 51 is changed to be dark, a display field 52 for displaying the recognized characters from the speech by the user is displayed below the icon 51.

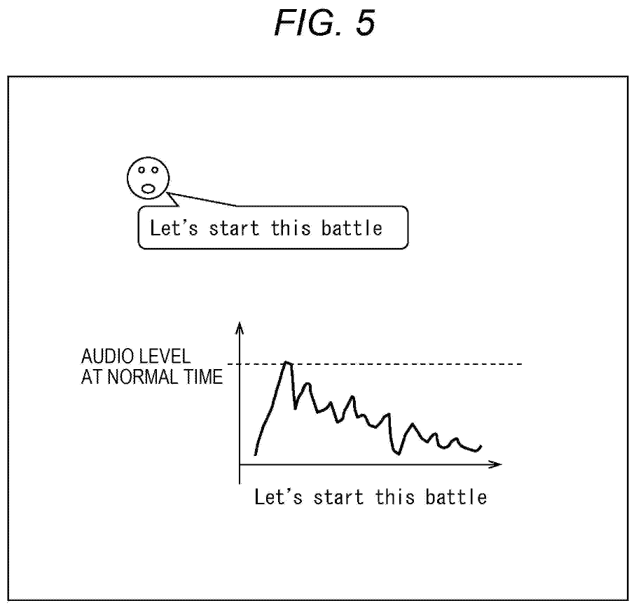

FIG. 5 shows a state in which the audio information up to “Let's start this battle” in the audio information “Let's start this battle BTX505” is supplied to the audio recognition server 14. First, the speech feature detection unit 23 of the audio recognition server 14 compares the audio level as processing of detecting the speech feature from the audio information “Let's start this battle”. In the example of FIG. 5, the audio level of the audio information “Let's start this battle” is equal to or lower than the audio level at the normal time, and the speech feature detection unit 23 supplies the speech feature detection result indicating that the audio level is equal to or lower than the audio level at the normal time, to the audio recognition mode switching processing unit 26.

Then, the audio recognition mode switching processing unit 26 determines that the audio recognition with respect to the audio information “Let's start this battle” is performed in the normal mode, in accordance with the speech feature detection result that the audio level of the audio information “Let's start this battle” is equal to or lower than the audio level at the normal mode. On the basis of this, the audio recognition mode switching processing unit 26 supplies the audio information “Let's start this battle” to the normal mode audio recognition unit 27, and the normal mode audio recognition unit 27 performs audio recognition processing of the normal mode.

For example, the normal mode audio recognition unit 27 supplies the character string “Let's start this battle” to the audio recognition result output processing unit 29 as the audio recognition result of the audio recognition processing of the normal mode. Therefore, the audio recognition result output processing unit 29 generates audio recognition result information for outputting the user interface that causes the user of the client terminal 13 to recognize that the audio recognition result “Let's start this battle” has been obtained, and supplies the audio recognition result information to the communication unit 21.

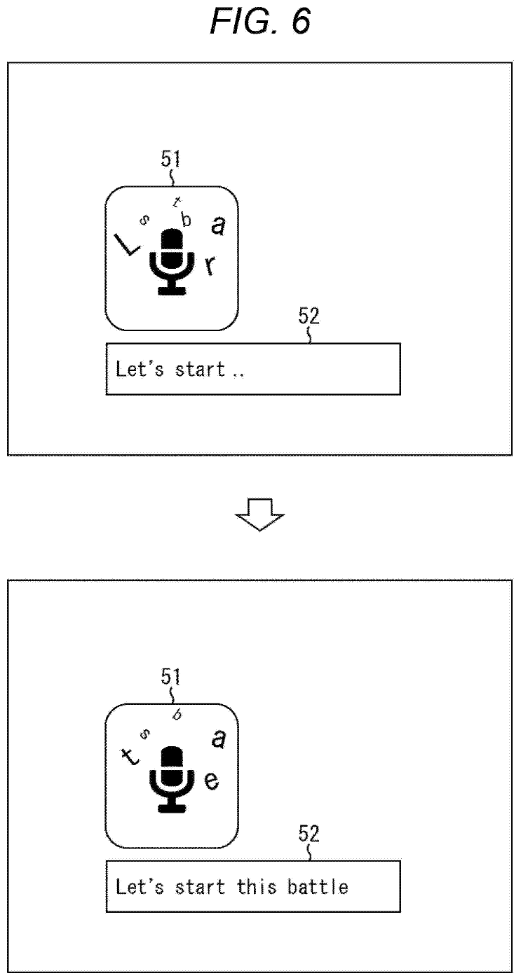

As a result, the client terminal 13 displays the user interface based on the audio recognition result obtained by the audio recognition processing of the normal mode. For example, as shown in FIG. 6, a user interface is displayed for dynamical display in which the audio recognition results in the midst of recognition by the audio recognition processing of the normal mode appears around the microphone of the icon 51. Furthermore, words in the midst of recognition by the audio recognition processing of the normal mode are sequentially displayed on the display field 52. In other words, as shown in the upper side of FIG. 6, the audio recognition result “Let's start . . . ” in the midst of recognition is displayed in the display field 52. Then, when all the audio recognition with respect to the audio information “Let's start this battle” is completed, the audio recognition result “Let's start this battle” is displayed in the display field 52 as shown in the lower side of FIG. 6.

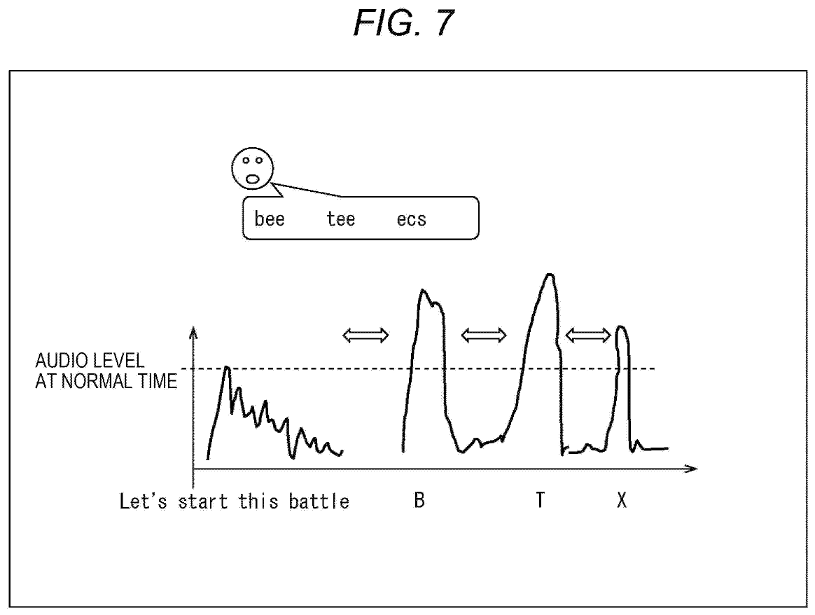

Next, FIG. 7 shows a state in which the audio information up to the audio information “BTX” subsequent to the audio information “Let's start this battle” in the audio information “Let's start this battle BTX505” is supplied to the audio recognition server 14. Note that, in a case where the audio recognition processing in the normal mode is performed on the audio information “BTX”, the audio recognition result “bee tee ecs” is obtained as shown in the drawing.

First, the speech feature detection unit 23 compares the audio levels as processing of detecting the speech feature from the audio information “BTX”. In the example of FIG. 7, the audio level of the audio information “BTX” exceeds the audio level at the normal time, and the speech feature detection unit 23 supplies the speech feature detection result indicating that the audio level exceeds the audio level at the normal time, to the audio recognition mode switching processing unit 26.

Furthermore, the specific silent period detection unit 24 performs processing of detecting a specific silent period from the audio information “BTX”. In the example of FIG. 7, the period shown by a while arrow is detected as the specific silent period, and the specific silent period detection unit 24 supplies the specific silent period detection result indicating the timing and the interval at which the specific silent period has been detected, to the audio recognition mode switching processing unit 26.

Then, the audio recognition mode switching processing unit 26 determines whether or not the audio recognition processing of the special mode is performed on the basis of the speech feature detection result supplied from the speech feature detection unit 23, and the specific silent period detection result supplied from the specific silent period detection unit 24. In the example shown in FIG. 7, the audio recognition mode switching processing unit 26 determines that the audio recognition processing of the special mode is performed on the basis of the fact that the audio level exceeds the audio level at the normal time, and the specific silent period is detected at predetermined timings and intervals.

Therefore, the audio recognition mode switching processing unit 26 supplies the audio information “BTX” to the special mode audio recognition unit 28, and the special mode audio recognition unit 28 performs audio recognition processing of the special mode.

For example, the special mode audio recognition unit 28 supplies an alphabet of capital letters “BTX” to the audio recognition result output processing unit 29 as the audio recognition result obtained by performing the audio recognition processing of the special mode (one-character mode and uppercase conversion mode). Therefore, the audio recognition result output processing unit 29 generates audio recognition result information for outputting the user interface that causes the user of the client terminal 13 to recognize that the audio recognition result of the uppercase alphabets “BTX” has been obtained, and supplies the audio recognition result information to the communication unit 21.

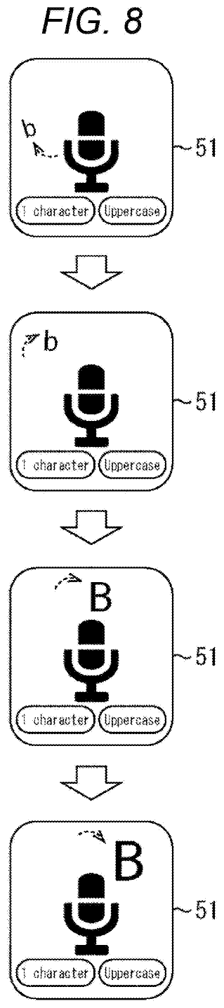

As a result, the client terminal 13 displays the user interface based on the audio recognition result obtained by the audio recognition processing of the special mode. In other words, as shown in FIG. 8, a mark “1 character” indicating the audio recognition processing of the one-character mode and a mark “Uppercase” indicating the audio recognition processing of the uppercase conversion mode in the audio recognition processing of the special mode, are displayed on the lower side of the icon 51. Then, a user interface is displayed for dynamical display in which the audio recognition results in the midst of recognition by the audio recognition processing of the one-character mode and the uppercase conversion mode is converted from lowercase letters to uppercase letters while moving around the microphone of the icon 51.

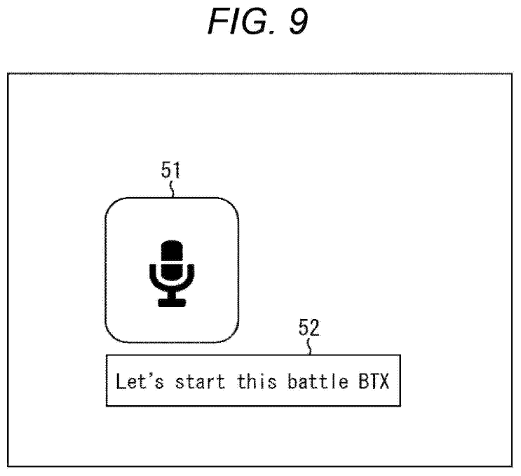

FIG. 8 shows an example of a user interface in which a lowercase letter “b” is converted to an uppercase letter “B”. However, similar processing is repeated for subsequent uppercase letter “T” and uppercase letter “X”. Then, when all the audio recognition with respect to the audio information “BTX” is completed, the audio recognition result “Let's start this battle BTX” is displayed in the display field 52 as shown in FIG. 9.

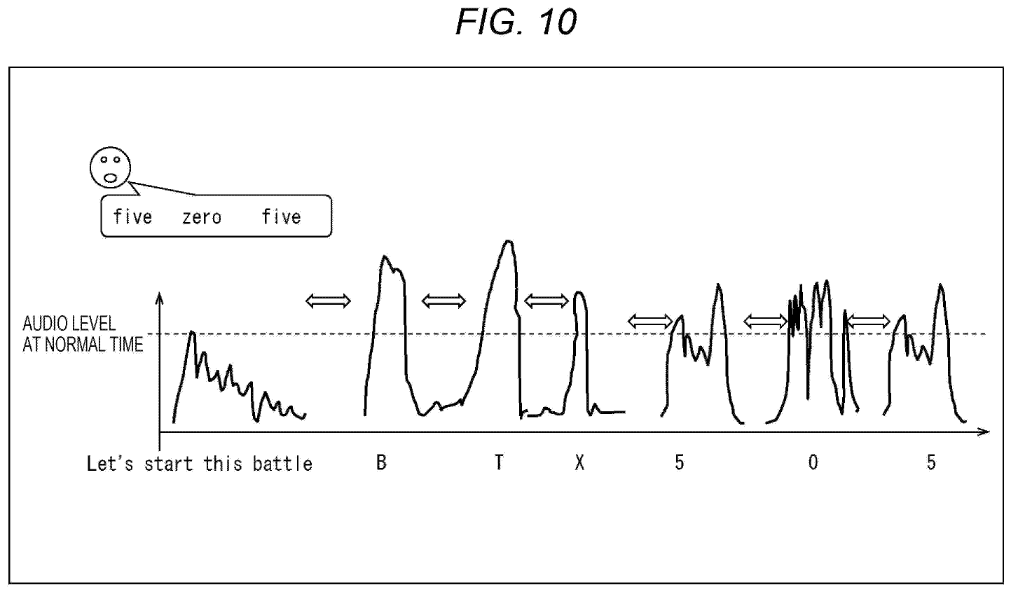

Next, FIG. 10 shows a state in which the audio information “505” is supplied subsequent to the audio information “Let's start this battle BTX” in the audio information “Let's start this battle BTX505”, to the audio recognition server 14. Note that, in a case where the audio recognition processing of the normal mode is performed on the audio information “505”, the audio recognition result “five zero five” is obtained as shown in the drawing.

First, the speech feature detection unit 23 compares the audio levels as processing of detecting the speech feature from the audio information “505”. In the example of FIG. 10, the audio level of the audio information “505” exceeds the audio level at the normal time, and the speech feature detection unit 23 supplies the speech feature detection result indicating that the audio level exceeds the audio level at the normal time, to the audio recognition mode switching processing unit 26.

Furthermore, the specific silent period detection unit 24 performs processing of detecting a specific silent period from the audio information “505”. In the example of FIG. 10, the period shown by a while arrow is detected as the specific silent period, and the specific silent period detection unit 24 supplies the specific silent period detection result indicating the timing and the interval at which the specific silent period has been detected, to the audio recognition mode switching processing unit 26.

Then, the audio recognition mode switching processing unit 26 determines whether or not the audio recognition processing of the special mode is performed on the basis of the speech feature detection result supplied from the speech feature detection unit 23, and the specific silent period detection result supplied from the specific silent period detection unit 24. In the example shown in FIG. 10, the audio recognition mode switching processing unit 26 determines that the audio recognition processing of the special mode is performed on the basis of the fact that the audio level exceeds the audio level at the normal time, and the specific silent period is detected at predetermined timings and intervals.

Therefore, the audio recognition mode switching processing unit 26 supplies the audio information “BTX” to the special mode audio recognition unit 28, and the special mode audio recognition unit 28 performs audio recognition processing of the special mode.

For example, the special mode audio recognition unit 28 supplies a number “505” to the audio recognition result output processing unit 29 as the audio recognition result obtained by performing the audio recognition processing of the special mode (one-character mode and number conversion mode). Therefore, the audio recognition result output processing unit 29 generates audio recognition result information for outputting the user interface that causes the user of the client terminal 13 to recognize that the audio recognition result of the number “505” has been obtained, and supplies the audio recognition result information to the communication unit 21.

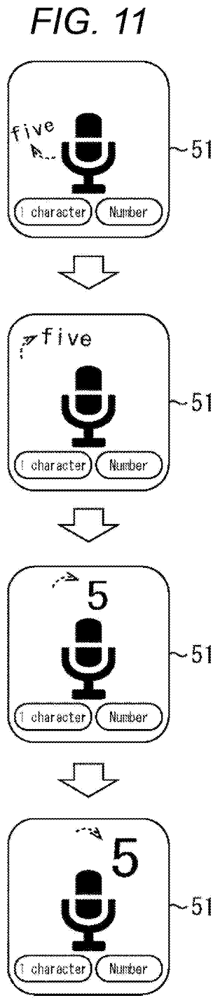

As a result, the client terminal 13 displays the user interface based on the audio recognition result obtained by the audio recognition processing of the special mode. In other words, as shown in FIG. 11, a mark “1 character” indicating the audio recognition processing of the one-character mode and a mark “Number” indicating the audio recognition processing of the number conversion mode in the audio recognition processing of the special mode, are displayed on the lower side of the icon 51. Then, a user interface is displayed for dynamical display in which the audio recognition results in the midst of recognition by the audio recognition processing of the one-character mode and the number conversion mode is converted from words to numbers while moving around the microphone of the icon 51.

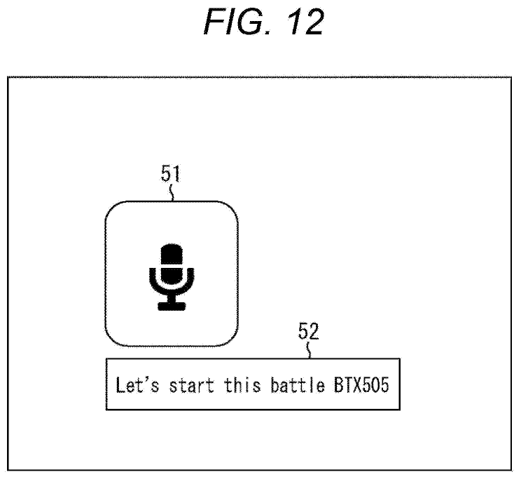

FIG. 11 shows an example of a user interface in which a word “five” is converted to a number “5”. However, similar processing is repeated for subsequent number “0” and number “5”. Then, when all the audio recognition with respect to the audio information “505” is completed, the audio recognition result “Let's start this battle BTX505” is displayed in the display field 52 as shown in FIG. 12.

<Description of Audio Recognition Processing>

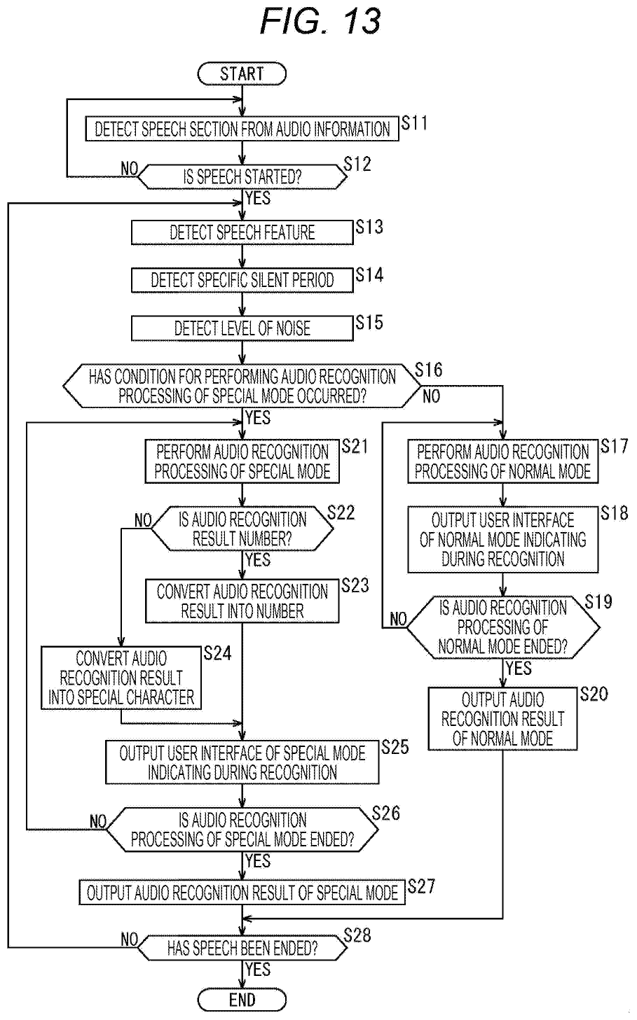

FIG. 13 is a flowchart explaining the audio recognition processing performed in the audio recognition server 14.

For example, the communication unit 21 receives the audio information transmitted from the client terminal 13 via the network 12 and supplies the audio information to the input sound processing unit 22, and then the processing starts. In step S11, the input sound processing unit 22 performs processing of detecting a speech section including the audio spoken by the user of the client terminal 13 from the audio information supplied from the communication unit 21.

In step S12, the input sound processing unit 22 determines whether or not the speech by the user of the client terminal 13 has started, according to the detection result of the speech section in the processing in step S11. In step S12, in a case where the input sound processing unit 22 determines that the speech has not started, the processing returns to step S11, and the processing is on standby until it is determined that the speech has started.

On the other hand, in step S12, in a case where the input sound processing unit 22 determines that the speech of the user of the client terminal 13 has started, the processing proceeds to step S13. At this time, the input sound processing unit 22 starts supplying of the audio information of the speech section to the speech feature detection unit 23, the specific silent period detection unit 24, the noise detection unit 25, and the audio recognition mode switching processing unit 26.

In step S13, the speech feature detection unit 23 performs processing of detecting the speech feature from the audio information of the speech section supplied from the input sound processing unit 22, and supplies the speech feature detection result to the audio recognition mode switching processing unit 26. For example, the speech feature detection result includes a result of comparison between the audio level of the audio information and the audio level at the normal time, a result of detection that the audio speed of the audio information is relatively decreased, a result of detection that the audio frequency of the audio information is relatively increased, and the like.

In step S14, the specific silent period detection unit 24 performs processing of detecting the specific silent period from the audio information of the speech section supplied from the input sound processing unit 22, and supplies the specific silent period detection result to the audio recognition mode switching processing unit 26 in a case of detecting the specific silent period. For example, the specific silent period detection result includes the timing and the interval at which the specific silent period detection unit 24 has detected the specific silent period.

In step S15, the noise detection unit 25 performs processing of detecting the noise from the audio information of the speech section supplied from the input sound processing unit 22, and supplies the noise detection result indicating that the noise has been detected, to the audio recognition mode switching processing unit 26, in a case of detecting noise of a predetermined level or higher.

In step S16, the audio recognition mode switching processing unit 26 determines whether or not a condition for performing the audio recognition processing of the special mode has occurred on the basis of the speech feature detection result, the specific silent period, and the noise detection result. For example, in a case where the audio level of the audio based on the audio information is larger than the audio level at the normal time and the specific silent period is detected twice or more for a predetermined period (for example, one to two seconds), the audio recognition mode switching processing unit 26 determines that a condition for performing the audio recognition processing in the special mode has occurred.

Similarly, in a case where the audio input speed based on the audio information is relatively slow, and the specific silent period is detected twice or more in a predetermined period, the audio recognition mode switching processing unit 26 determines that a condition for performing the audio recognition processing in the special mode has occurred. Furthermore, in a case where the frequency of the audio based on the audio information is relatively high, and the specific silent period is detected twice or more in a predetermined period, the audio recognition mode switching processing unit 26 determines that a condition for performing the audio recognition processing of the special mode has occurred. For example, when speaking special characters such as an ID, a user generally tends to speak with a larger voice than a normal conversation, speak in a slow tone, or speak with a high voice. Therefore, it is preferable to select the audio recognition processing of the special mode under the above-mentioned conditions. Furthermore, in a case where the noise detection result indicates that noise of a predetermined level or higher is detected, the audio recognition mode switching processing unit 26 does not select the audio recognition processing of the special mode, and causes the audio recognition processing of the normal mode to be performed.

In step S16, in a case where the audio recognition mode switching processing unit 26 determines that the condition for performing the audio recognition processing of the special mode has not occurred, the processing proceeds to step S17.

In step S17, the audio recognition mode switching processing unit 26 supplies the audio information of the speech section supplied from the input sound processing unit 22 to the normal mode audio recognition unit 27, and the normal mode audio recognition unit 27 performs the audio recognition processing of the normal mode.

In step S18, the normal mode audio recognition unit 27, for example, in every time when recognizing a word from the audio information, supplies the word to the audio recognition result output processing unit 29 as an audio recognition result. The audio recognition result output processing unit 29 generates audio recognition result information for outputting the user interface that causes the user of the client terminal 13 to recognize that it is the audio recognition result obtained by the audio recognition processing of the normal mode, and supplies the audio recognition result information to the communication unit 21. As a result, in the client terminal 13, the user interface as described above is displayed with reference to FIG. 6.

In step S19, the audio recognition mode switching processing unit 26 determines whether or not the audio recognition processing of the normal mode is ended. For example, as similar to step S16, the audio recognition mode switching processing unit 26 constantly monitors whether or not a condition for performing the audio recognition processing of the special mode has occurred, and when a condition for performing the audio recognition processing of the special mode has occurred, the audio recognition mode switching processing unit 26 determines that the audio recognition processing of the normal mode is ended. Furthermore, for example, also when supply of the audio information of the speech section from the input sound processing unit 22 has stopped, the audio recognition mode switching processing unit 26 determines that the audio recognition processing of the normal mode is ended.

In step S19, in a case where the audio recognition mode switching processing unit 26 determines that the audio recognition processing of the normal mode is not ended, the processing returns to step S17, and similar processing is repeated thereafter. On the other hand, in step S19, in a case where the audio recognition mode switching processing unit 26 determines that the audio recognition processing of the normal mode is ended, the processing proceeds to step S20.

In step S20, the normal mode audio recognition unit 27 supplies the audio recognition result for a period from when the audio recognition processing of the normal mode starts until the audio recognition processing ends, to the audio recognition result output processing unit 29. The audio recognition result output processing unit 29 generates audio recognition result information for outputting the user interface that presents the audio recognition result to the user, and supplies the audio recognition result information to the communication unit 21. As a result, at this time, the client terminal 13 displays the user interface indicating the audio recognition result recognized by the audio recognition processing of the normal mode.

On the other hand, in step S16, in a case where the audio recognition mode switching processing unit 26 determines that the condition for performing the audio recognition processing of the special mode has occurred, the processing proceeds to step S21.

In step S21, the audio recognition mode switching processing unit 26 supplies the audio information of the speech section supplied from the input sound processing unit 22 to the special mode audio recognition unit 28, and the special mode audio recognition unit 28 performs the audio recognition processing of the special mode.

In step S22, the special mode audio recognition unit 28 refers to the character string number conversion table as shown in FIG. 3, and determines whether or not the audio recognition result is a number.

In step S22, in a case where the special mode audio recognition unit 28 determines that the audio recognition result is a number, the processing proceeds to step S23, and the special mode audio recognition unit 28 converts the audio recognition result into a number.

On the other hand, in step S22, in a case where the special mode audio recognition unit 28 determines that the audio recognition result is not a number, the processing proceeds to step S24, and the special mode audio recognition unit 28 changes the audio recognition result into a special character.

After processing of step S23 or S24, the processing proceeds to step S25, for example, in every time when recognizing a number or a special character from the audio information, the special mode audio recognition unit 28 supplies the audio recognition result to the audio recognition result output processing unit 29. The audio recognition result output processing unit 29 generates audio recognition result information for outputting the user interface that causes the user of the client terminal 13 to recognize that it is the audio recognition result obtained by the audio recognition processing of the special mode, and supplies the audio recognition result information to the communication unit 21. As a result, in the client terminal 13, the user interface as described above with reference to FIGS. 8 and 11 is displayed.

In step S26, the audio recognition mode switching processing unit 26 determines whether or not the audio recognition processing of the special mode is ended. For example, the audio recognition mode switching processing unit 26 constantly monitors whether or not a condition for performing the audio recognition processing of the special mode that has occurred in step S16 continues, and when a condition for performing the audio recognition processing of the special mode does not continue anymore, the audio recognition mode switching processing unit 26 determines that the audio recognition processing of the special mode is ended. Furthermore, for example, also when supply of the audio information of the speech section from the input sound processing unit 22 has stopped, the audio recognition mode switching processing unit 26 determines that the audio recognition processing of the special mode is ended.

In step S26, in a case where the audio recognition mode switching processing unit 26 determines that the audio recognition processing of the special mode is not ended, the processing returns to step S21, and similar processing is repeated thereafter. On the other hand, in step S26, in a case where the audio recognition mode switching processing unit 26 determines that the audio recognition processing of the special mode is ended, the processing proceeds to step S27.

In step S27, the special mode audio recognition unit 28 supplies the audio recognition result for a period from when the audio recognition processing of the special mode starts until the audio recognition processing ends, to the audio recognition result output processing unit 29. The audio recognition result output processing unit 29 generates audio recognition result information for outputting the user interface that presents the audio recognition result to the user, and supplies the audio recognition result information to the communication unit 21. As a result, at this time, the client terminal 13 displays the user interface indicating the audio recognition result recognized by the audio recognition processing of the special mode.

After processing of step S20 or S27, the processing proceeds to step S28, and the input sound processing unit 22 determines whether or not the speech by the user of the client terminal 13 has been ended. In step S28, in a case where the input sound processing unit 22 determines that the speech has not ended, the processing returns to step S13, and similar processing is repeated thereafter.

On the other hand, in step S28, in a case where the input sound processing unit 22 determines that the speech of the user of the client terminal 13 has ended, the audio recognition processing is ended.

As described above, the audio recognition server 14 can switch the audio recognition processing of the normal mode and the audio recognition processing of the special mode on the basis of the speech feature detection result, the specific silent period, and the noise detection result. As a result, the audio recognition server 14 can perform appropriate audio recognition processing in a case where a special character is included in the middle of a normal conversation, so that more preferable audio input can be provided.

<Audio recognition processing for Japanese>

The audio recognition system 11 can cope with audio recognition processing for Japanese.

As described above, in the audio recognition processing for English, the uppercase conversion mode is performed in the special mode audio recognition unit 28. On the other hand, in the audio recognition processing for Japanese, for example, it is possible to perform a conversion mode to convert to Hiragana or Katakana in the special mode audio recognition unit 28.

For example, in a case where the specific silent period detection unit 24 detects a specific silent period from the audio information, the audio recognition mode switching processing unit 26 determines that the user needs audio recognition of one character by one character, and the special mode audio recognition unit 28 performs audio recognition processing of the one-character mode.

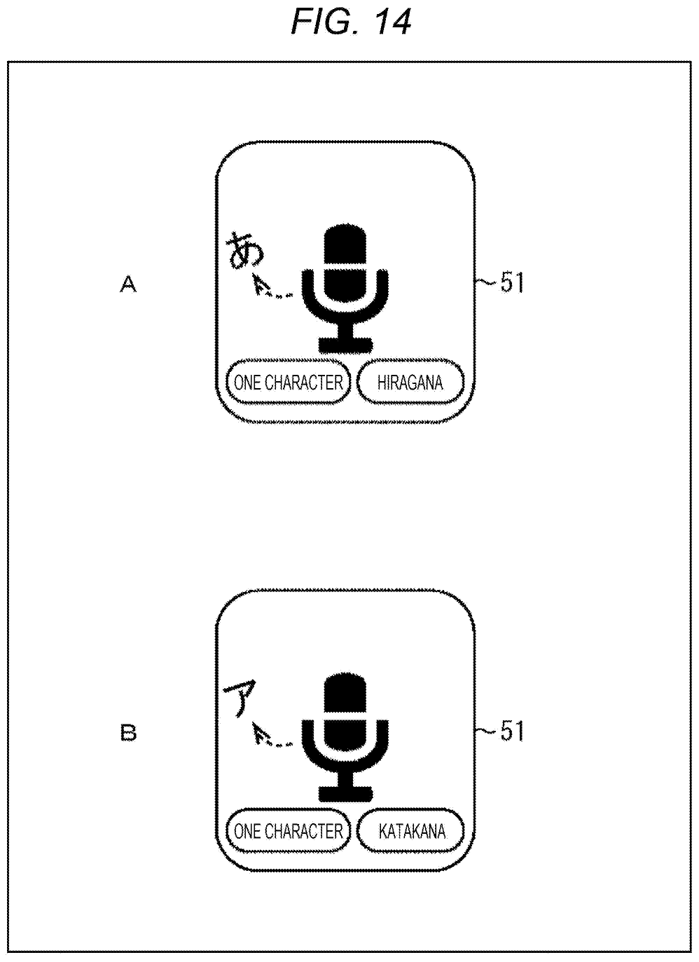

At this time, when the speech feature detection unit 23 detects that the audio level of the audio information is equal to or lower than the audio level at the normal time, the special mode audio recognition unit 28 performs audio recognition processing in the hiragana mode. As a result, as shown in A in FIG. 14, a mark “one character” indicating the audio recognition processing of the one-character mode and a mark “hiragana” indicating the audio recognition processing of the hiragana mode in the audio recognition processing of the special mode, are displayed on the lower side of the icon 51.

On the other hand, when the speech feature detection unit 23 detects that the audio level of the audio information exceeds the audio level at the normal time, the special mode audio recognition unit 28 performs audio recognition processing in the katakana mode. As a result, as shown in B in FIG. 14, a mark “one character” indicating the audio recognition processing of the one-character mode and a mark “katakana” indicating the audio recognition processing of the katakana mode in the audio recognition processing of the special mode, are displayed on the lower side of the icon 51.

In this manner, the audio recognition system 11 can perform the audio recognition processing of the special mode suitable for each language.

<API of Audio Recognition System>

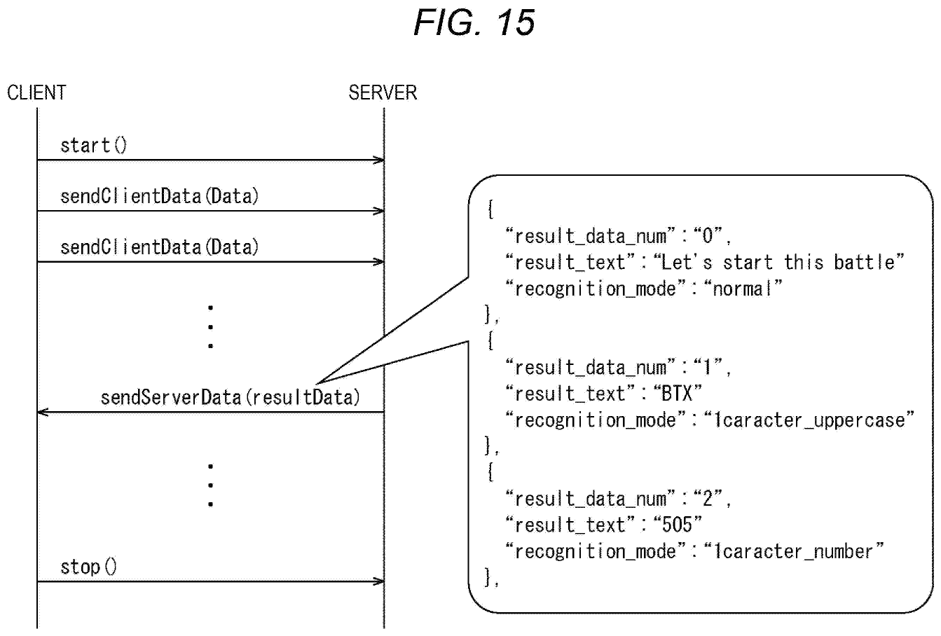

FIG. 15 shows an example of an application programming interface (API) for realizing the audio recognition processing by the audio recognition system 11.

First, when it is detected the speech by the user starts in the client terminal 13, a start command (start ( )) giving an instruction on the start of the audio recognition processing is transmitted from the client terminal 13 to the audio recognition server 14.

Subsequently, client transmission data (send Client Data (Data)) is sequentially transmitted from the client terminal 13 to the audio recognition server 14. In the client transmission data, for example, the audio information “Let's start this battle”, the audio information “BTX”, and the audio information “505” as described above are stored as data.

Then, after the audio recognition processing is performed in the audio recognition server 14, server transmission data (send Server Data (result Data)) is sequentially transmitted from the audio recognition server 14 to the client terminal 13. In the server transmission data, for example, the audio recognition result “Let's start this battle”, the audio recognition result “BTX”, and the audio recognition result “505” as described above are stored as data. Furthermore, each audio recognition result includes a data number (result_data_num), text (result text), and mode information (recognition_mode).

Such data transmission and reception is performed between the client terminal 13 and the audio recognition server 14. Thereafter, when it is detected that the speech by the user ends in the client terminal 13, a stop command (stop( )) giving an instruction on the end of the audio recognition processing is transmitted from the client terminal 13 to the audio recognition server 14.

With the API as described above, the audio recognition processing by the audio recognition system 11 can be realized.

<Display Example of Audio Recognition Result>

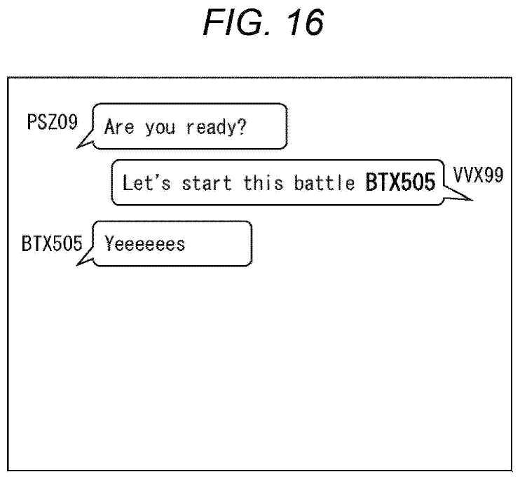

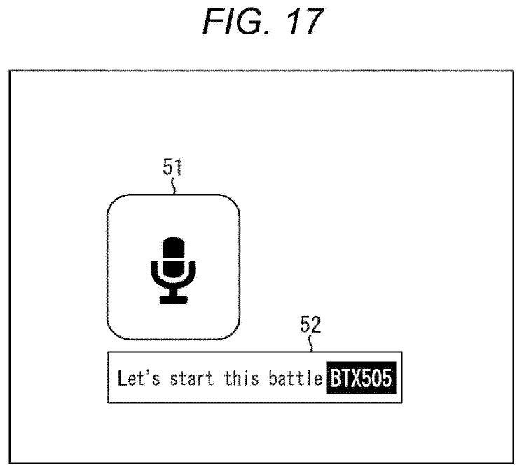

A display example of the audio recognition result in the client terminal 13 will be described with reference to FIG. 16 and FIG. 17.

As shown in FIG. 16, in the client terminal 13, for example, audio recognition can be adopted in a chat application. FIG. 16 shows an example in which a comment “Let's start this battle BTX505” by a user name “VVX99” is returned in response to a comment “Are you ready?” by a user name “PSZ09” and a comment “Yeeeeees” by a user name “BTX505” is performed.

At this time, a friend list in which the user names for chatting are registered is held in the client terminal 13, and for example, in the friend list of the user name “VVX99”, the user name “PSZ09” and the user name “BTX505” and the like are registered. Therefore, in a case where the user name registered in the friend list is obtained as the audio recognition result, the client terminal 13 can emphasize and display the user name.

In the example shown in FIG. 16, the user name “BTX505” of the comment “Let's start this battle BTX505” by the user name “VVX99” is decorated so as to be emphasized in bold.

Similarly, FIG. 17 shows an example in which the user name “BTX505” is emphasized by highlight display in the display field 52.

In this way, the user name registered in the friend list is emphasized and displayed in the client terminal 13, the user can easily visually recognize that the audio recognition result is a user name. Note that, for example, the audio recognition result output processing unit 29 may designate such emphasizing and displaying of the user name by the audio recognition result information and cause the client terminal 13 to perform emphasizing and displaying.

Furthermore, as similar to the user name, the client terminal 13 emphasizes and displays the audio recognition result obtained by performing the audio recognition processing of the special mode by the special mode audio recognition unit 28, so as to assist the user to recognize that the audio recognition result is a special character such as abbreviation or a number. In this way, the user recognizes a special character at a glance, so that communication is smoothly performed, and it is easy for the user to concentrate on the original work.

In addition, the client terminal 13 can emphasize the audio recognition result by various methods, for example, by changing the color of the character, changing the size, or highlighting. Note that in a case where the audio recognition result is output by synthesized audio, the client terminal 13 can output the audio recognition result by the audio recognition processing of the normal mode at the normal volume, and output the audio recognition result by the audio recognition processing of the special mode at a volume larger than normal. Alternatively, the sound quality at the time of outputting the audio recognition result by the audio recognition processing of the special mode may be changed. This makes it easy for the user to recognize special characters and the like.

As described above, the audio recognition result output processing unit 29 can generate the audio recognition result information for changing the representation of the user interface, between the audio recognition result by the audio recognition processing of the normal mode and the audio recognition result by the audio recognition processing of the special mode.

Note that, for example, in a case where, even if the audio recognition processing of the normal mode is repeated a plurality of times, similar audio information is supplied, in other words, a user repeats the same speech, the audio recognition mode switching processing unit 26 may determine that the audio recognition result is wrong and perform the audio recognition processing of the special mode. Furthermore, in a case where information that the user performs the operation of deleting all the audio input to the same audio recognition result is supplied, it can be determined that the audio recognition result is wrong. Therefore, in this case, for example, even if the audio recognition mode switching processing unit 26 performs the audio recognition processing of the normal mode three times, when deletion of all the audio input is repeatedly performed, the audio recognition mode switching processing unit 26 can perform the audio recognition processing of the special mode with respect to the audio information to be supplied next.

Furthermore, for example, the audio recognition mode switching processing unit 26 can determine the selection of the audio recognition processing of the special mode according to an attribute of the text field to be subjected to audio input. For example, a text field for entering a zip code has an attribute for inputting only numbers, so that the audio recognition mode switching processing unit 26 can determine to perform the number conversion mode in the audio recognition processing of the special mode.

Incidentally, in a case where the reliability of one of the audio recognition results of the audio recognition result “BTX” and the audio recognition result “505” for the user name “BTX505” as described above is low, the special mode audio recognition unit 28 can display only one of the audio recognition results. In other words, with respect to such a user name, a user can recognize that it is a user name more smoothly in a case of display of only a part being a correct audio recognition result, rather than display of an audio recognition result of which a part is wrong.

Furthermore, for example, in a case where an operation for giving an instruction on the audio recognition processing of the special mode is performed in the client terminal 13, the audio recognition mode switching processing unit 26 can switch the mode to the audio recognition processing of the special mode according to the operation.

Moreover, in the audio recognition system 11, instead of connecting only one audio recognition server 14, for example, a plurality of audio recognition servers 14 may be connected so that audio recognition processing of the same audio information can be simultaneously performed by each of the audio recognition servers 14. In this case, it is possible to provide a user interface such that a plurality of audio recognition results are presented with reliability added thereto and can be selected by the user.

Note that each processing that has been described with reference to the flow charts described above need not always be performed in chronological order in accordance with the order described in the flowchart, but may be performed in parallel or individually (for example, parallel processing or processing by an object). Furthermore, the program may be processed by one central processing unit (CPU) or processed by distributed processing by a plurality of CPUs.

Furthermore, the series of processing described above (information processing method) can be also executed by hardware. However, the series of processing can also be executed by software. In a case of executing the series of processing by software, a program included in the software is installed from a program recording medium in which a program is recorded, to a computer incorporated in dedicated hardware, or a general personal computer or the like, for example, that can execute various functions by installing various programs.

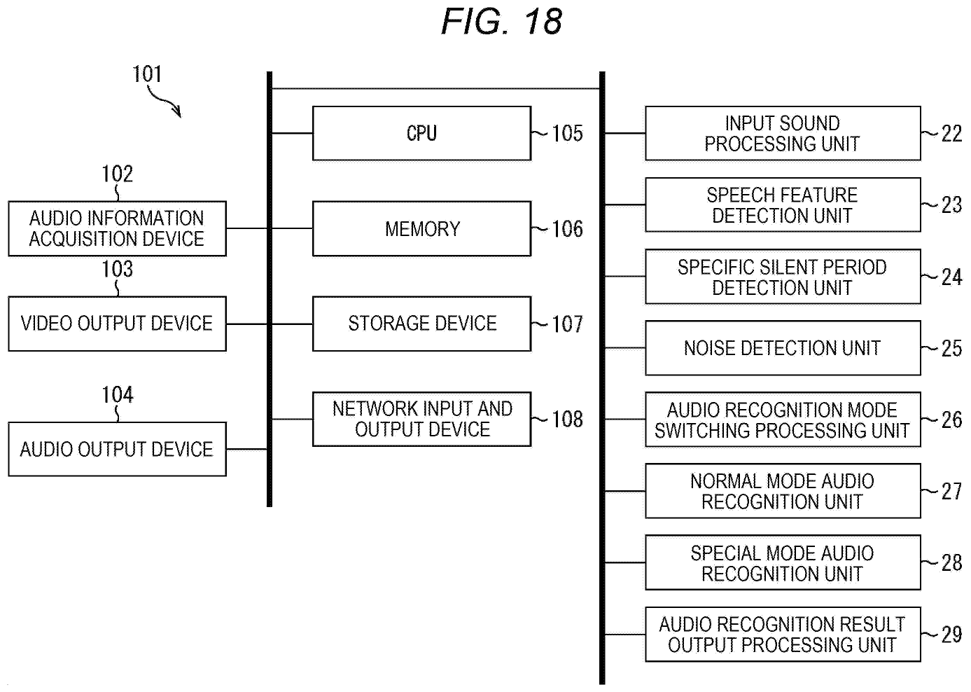

FIG. 18 is a block diagram showing an example of a hardware configuration of a computer that executes the above-described series of processing by a program.

Here, a computer 101 shown in FIG. 18 corresponds to, for example, the client terminal 13 in FIG. 1, and FIG. 18 shows a configuration example in which processing can be performed by the client terminal 13 alone without processing via the network 12.

The computer 101 includes an audio information acquisition device 102, a video output device 103, an audio output device 104, a CPU 105, a memory 106, a storage device 107, and a network input and output device 108. Moreover, as similar to the audio recognition server 14 shown in FIG. 2, the computer 101 includes the communication unit 21, the input sound processing unit 22, the speech feature detection unit 23, the specific silent period detection unit 24, the noise detection unit 25, the audio recognition mode switching processing unit 26, the normal mode audio recognition unit 27, the special mode audio recognition unit 28, and the audio recognition result output processing unit 29.

For example, the audio information acquisition device 102 includes a microphone, the video output device 103 includes a display, and the audio output device 104 includes a speaker. Furthermore, the network input and output device 108 corresponds to the communication unit 21 of FIG. 2, and can perform communication according to the standard of the local area network (LAN), for example.

Then, in the computer 101, the CPU 105 reads the program stored in the storage device 107 to the memory 106 and executes the program, so that the above-described series of processing is performed.

Note that the program to be executed by the CPU 105 can be provided by being recorded in a package medium including, for example, a magnetic disk (including a flexible disk), an optical disk (a compact disc-read only memory (CD-ROM), a digital versatile disc (DVD), or the like), a magneto-optical disc, a semiconductor memory, or the like, or can be provided via a wired or wireless transmission medium by utilizing the network input and output device 108.

Note that, the present technology can adopt the following configuration.

(1)

An information processing apparatus including:

a speech feature detection unit that acquires audio information obtained by a speech of a user and detects a feature of the speech from the audio information;

a specific silent period detection unit that detects a specific silent period that is a specific short silent period not determined as a silent period in processing of detecting a speech section in which the audio information includes audio;

a selection unit that selects audio recognition processing to be performed on the audio information on the basis of the feature of the speech that has been detected from the audio information by the speech feature detection unit, and the specific silent period that has been detected from the audio information by the specific silent period detection unit; and

an output processing unit that outputs, along with an audio recognition result obtained by recognition in the audio recognition processing that has been selected by the selection unit, an audio recognition result information indicating the audio recognition processing in which the audio recognition result has been obtained.

(2)

The information processing apparatus described in (1) above, in which

the selection unit selects either audio recognition processing of a normal mode for recognizing a normal character string or audio recognition processing of a special mode for recognizing a special character string as the audio recognition processing performed on the audio information.

(3)

The information processing apparatus described in (2) above in which

in a case where it is determined that the specific feature has been detected from the audio information by the speech feature detection unit, and determined that the specific silent period has been repeatedly detected at a predetermined interval from the audio information by the specific silent period detection unit, the selection unit selects the audio recognition processing of the special mode.

(4)

The information processing apparatus described in (3) above in which

the speech feature detection unit detects an audio level of the audio based on the audio information as the feature of the speech, and

in a case where the audio level of the audio exceeds a preset predetermined audio level, the selection unit determines that the specific feature has been detected from the audio information.

(5)

The information processing apparatus described in (3) or (4) above in which

the speech feature detection unit detects an input speed of the audio based on the audio information as the feature of the speech, and

in a case where a change has occurred in which the input speed of the audio detected by the speech feature detection unit becomes relatively slow, the selection unit determines that the specific feature has been detected from the audio information.

(6)

The information processing apparatus described in any of (3) to (5) above in which

the speech feature detection unit detects a frequency of the audio based on the audio information as the feature of the speech, and

in a case where a change has occurred in which the frequency of the audio detected by the speech feature detection unit becomes relatively high, the selection unit determines that the specific feature has been detected from the audio information.

(7)

The information processing apparatus described in any of (2) to (6) above, in which

in the audio recognition processing of the special mode, words recognized by audio recognition are converted into numbers and are output.

(8)

The information processing apparatus described in any of (2) to (7) above, in which

in the audio recognition processing of the special mode, alphabets recognized by audio recognition are converted into uppercase letters one character by one character and are output.

(9)

The information processing apparatus described in any of (2) to (8) above, in which

in the audio recognition processing of the special mode, each one character recognized by audio recognition is converted into katakana and is output.

(10)

The information processing apparatus described in any of (2) to (9) above,

further including a noise detection unit that detects an audio level of noise included in the audio information,

in which, in a case where the audio level of the noise exceeds a preset predetermined audio level, the selection unit avoids selection of the audio recognition processing of the special mode.

(11)

The information processing apparatus described in any of (2) to (10) above, in which

the output processing unit changes representation of a user interface between an audio recognition result by the audio recognition processing of the normal mode and an audio recognition result by the audio recognition processing of the special mode.

(12)

The information processing apparatus described in any of (1) to (11) above,

further including:

a communication unit that communicates with another apparatus via a network; and

an input sound processing unit that performs processing of detecting a speech section in which the audio information includes audio,

in which the communication unit

acquires the audio information transmitted from the another apparatus via the network, supplies the audio information to the input sound processing unit, and

transmits the audio recognition result information output from the output processing unit to the another device via the network.

(13)

An information processing method including steps of:

acquiring audio information obtained by a speech of a user and detecting a feature of the speech from the audio information;

detecting a specific silent period that is a specific short silent period not determined as a silent period in processing of detecting a speech section in which the audio information includes audio;

selecting audio recognition processing to be performed on the audio information on the basis of the feature of the speech that has been detected from the audio information, and the specific silent period that has been detected from the audio information; and

outputting, along with an audio recognition result obtained by recognition in the audio recognition processing that has been selected, an audio recognition result information indicating the audio recognition processing in which the audio recognition result has been obtained.

(14)

A program that causes a computer to execute information processing including steps of:

acquiring audio information obtained by a speech of a user and detecting a feature of the speech from the audio information;

detecting a specific silent period that is a specific short silent period not determined as a silent period in processing of detecting a speech section in which the audio information includes audio;

selecting audio recognition processing to be performed on the audio information on the basis of the feature of the speech that has been detected from the audio information, and the specific silent period that has been detected from the audio information; and

outputting, along with an audio recognition result obtained by recognition in the audio recognition processing that has been selected, an audio recognition result information indicating the audio recognition processing in which the audio recognition result has been obtained.

Note that the present embodiment is not limited to the above-described embodiments, and various modifications are possible without departing from the gist of the present disclosure.

### REFERENCE SIGNS LIST

11 Audio recognition system
12 Network
13 Client terminal
14 Audio recognition server
21 Communication unit
22 Input sound processing unit
23 Speech feature detection unit
24 Specific silent period detection unit
25 Noise detection unit
26 Audio recognition mode switching processing unit
27 Normal mode audio recognition unit
28 Special mode audio recognition unit
29 Audio recognition result output processing unit
51 Icon
52 Display field
101 Computer
102 Audio information acquisition device
103 Video output device
104 Audio output device
105 CPU
106 Memory
107 Storage device
108 Network input and output device

1. An information processing apparatus comprising:
a speech feature detection unit that acquires audio information obtained by a speech of a user and detects a feature of the speech from the audio information;
a specific silent period detection unit that detects a specific silent period that is a specific short silent period not determined as a silent period in processing of detecting a speech section in which the audio information includes audio;
a selection unit that selects audio recognition processing to be performed on the audio information on the basis of the feature of the speech that has been detected from the audio information by the speech feature detection unit, and the specific silent period that has been detected from the audio information by the specific silent period detection unit; and
an output processing unit that outputs, along with an audio recognition result obtained by recognition in the audio recognition processing that has been selected by the selection unit, an audio recognition result information indicating the audio recognition processing in which the audio recognition result has been obtained.

2. The information processing apparatus according to claim 1, wherein
the selection unit selects either audio recognition processing of a normal mode for recognizing a normal character string or audio recognition processing of a special mode for recognizing a special character string as the audio recognition processing performed on the audio information.

3. The information processing apparatus according to claim 2, wherein
in a case where it is determined that the specific feature has been detected from the audio information by the speech feature detection unit, and determined that the specific silent period has been repeatedly detected at a predetermined interval from the audio information by the specific silent period detection unit, the selection unit selects the audio recognition processing of the special mode.

4. The information processing apparatus according to claim 3, wherein
the speech feature detection unit detects an audio level of the audio based on the audio information as the feature of the speech, and
in a case where the audio level of the audio exceeds a preset predetermined audio level, the selection unit determines that the specific feature has been detected from the audio information.

5. The information processing apparatus according to claim 3, wherein
the speech feature detection unit detects an input speed of the audio based on the audio information as the feature of the speech, and
in a case where a change has occurred in which the input speed of the audio detected by the speech feature detection unit becomes relatively slow, the selection unit determines that the specific feature has been detected from the audio information.

6. The information processing apparatus according to claim 3, wherein
the speech feature detection unit detects a frequency of the audio based on the audio information as the feature of the speech, and
in a case where a change has occurred in which the frequency of the audio detected by the speech feature detection unit becomes relatively high, the selection unit determines that the specific feature has been detected from the audio information.

7. The information processing apparatus according to claim 2, wherein
in the audio recognition processing of the special mode, words recognized by audio recognition are converted into numbers and are output.

8. The information processing apparatus according to claim 2, wherein
in the audio recognition processing of the special mode, alphabets recognized by audio recognition are converted into uppercase letters one character by one character and are output.

9. The information processing apparatus according to claim 2, wherein
in the audio recognition processing of the special mode, each one character recognized by audio recognition is converted into katakana and is output.

10. The information processing apparatus according to claim 2,
further comprising a noise detection unit that detects an audio level of noise included in the audio information,
wherein, in a case where the audio level of the noise exceeds a preset predetermined audio level, the selection unit avoids selection of the audio recognition processing of the special mode.

11. The information processing apparatus according to claim 2, wherein
the output processing unit changes representation of a user interface between an audio recognition result by the audio recognition processing of the normal mode and an audio recognition result by the audio recognition processing of the special mode.

12. The information processing apparatus according to claim 1,
further comprising:
a communication unit that communicates with another apparatus via a network; and
an input sound processing unit that performs processing of detecting a speech section in which the audio information includes audio,
wherein the communication unit
acquires the audio information transmitted from the another apparatus via the network, supplies the audio information to the input sound processing unit, and
transmits the audio recognition result information output from the output processing unit to the another device via the network.

13. An information processing method comprising steps of:
acquiring audio information obtained by a speech of a user and detecting a feature of the speech from the audio information;
detecting a specific silent period that is a specific short silent period not determined as a silent period in processing of detecting a speech section in which the audio information includes audio;
selecting audio recognition processing to be performed on the audio information on the basis of the feature of the speech that has been detected from the audio information, and the specific silent period that has been detected from the audio information; and
outputting, along with an audio recognition result obtained by recognition in the audio recognition processing that has been selected, an audio recognition result information indicating the audio recognition processing in which the audio recognition result has been obtained.

14. A program that causes a computer to execute information processing comprising steps of:
acquiring audio information obtained by a speech of a user and detecting a feature of the speech from the audio information;
detecting a specific silent period that is a specific short silent period not determined as a silent period in processing of detecting a speech section in which the audio information includes audio;
selecting audio recognition processing to be performed on the audio information on the basis of the feature of the speech that has been detected from the audio information, and the specific silent period that has been detected from the audio information; and
outputting, along with an audio recognition result obtained by recognition in the audio recognition processing that has been selected, an audio recognition result information indicating the audio recognition processing in which the audio recognition result has been obtained.
